(19) United States
(12) Patent Application Publication
(10) Pub. No.: US 2009/0138475 A1
(43) Pub. Date: May 28, 2009

(54) Method for creating a web-based contact book which includes multi-sourced contact-generated content (from social networks) in a custom and private stand-alone contact book with information selectively pulled from multiple outside sources, including multiple social networks, via a unique combination of a user decision node and a main and subordinated data tables structure, yielding no explicit or implicit source level value judgments or biases

(75) Inventor: Horace James Caulkins, Chappaqua, NY (US)

Correspondence Address: HJCV, LLC, 24 CREST ROAD, CHAPPAQUA, NY, 10514, US

(73) Assignee: HJCV LLC, Chappaqua, NY (US)

(21) Appl. No.: 12/237,314

(22) Filed: Sep. 24, 2008

Related U.S. Application Data
(60) Provisional application No. 60/990,600, filed on Nov. 27, 2007.

(51) Int. Cl. G06F 7/06; G06F 17/30

(52) U.S. Cl. 707/9; 707/10

(57) ABSTRACT

The growth of the World Wide Web has yielded many new and diverse sources of contact information. These sources need to be properly synchronized in order to be effectively integrated and ultimately useful. It is also important to maintain the integrity, customization and privacy required of a proper contact book. Current contact book models and mechanisms for synchronization all rely on explicit, inherent or implicit value judgments on the validity of the sources (examples include: choosing one source exclusively over others, choosing the latest information input as the best, or creating a hierarchy of sources, or implicitly creating biases when a source synching sequence is required) which are then blindly applied across the synchronization process. Information is then placed directly into the contact book, often without consulting the user for a decision, and with the potential to overwrite correct information. These source level value judgments and biases yield problems which lead to loss of information and ultimately distrust of the content of the contact management system, among other problems. Our novel model consists of a stand-alone, custom and private contact book for each user; the content in this contact book is either entered directly by the user, or selectively pulled from exogenous sources (either outside offline contact management systems, outside online contact management systems or outside online social networks). This is achieved using multiple subordinated information tables (each for a different information source) and a main information table, and creating a user decision node located between the main table and the subordinated tables controlling the flow of information. Thus, our system harnesses all of the information sources and incorporates user discretion in dictating the flow of information. Our invention is not vulnerable to loss of information, and the user control over the process will lead to greater trust in the content. This innovation and system of combining the data table structure and the user decision node yields valuable improvements over the current technologies.

This application claims the priority of provisional application No. 60990600 received by the USPTO on Nov. 27, 2007.

### TECHNICAL FIELD AND APPLICABILITY OF THE INVENTION

The invention applies generally to methods, systems and mechanisms for managing a database of contact information with multiple information sources. More specifically, it applies to a mechanism by which a user can create a private and custom web-based contact book (or main data table) with information sourced from multiple exogenous sources (each with a corresponding subordinated data table), such as networks of other users, or “social networks;” and how discrepancies between these various subordinated tables and the main table are resolved, specifically, by a user decision node. Most importantly, the creation of entries in this contact book is not limited to other users in the networks of other users, or “social networks,” and the flow of information into the contact book is controlled by the user. This is achieved by a novel model consisting of a stand-alone, custom and private contact book for each user, the content in this contact book is either entered directly by the user, or selectively pulled from exogenous sources (either outside offline contact management systems, outside online contact management systems or outside online social networks) by the user via a user decision node. Thus, the contact book has the advantage of being customized to and controlled by the user, and simultaneously maintains the ability to pull information from outside sources and social networks. This innovation is uniquely achievable through the combination of the user decision node in the synchronization process with the use the main and subordinated tables structure.

### BACKGROUND OF THE INVENTION

Management and maintenance of personal and professional contact information has always been a paramount concern for many individuals and entities. This need has been targeted by numerous parties and with numerous utilities. There is a plethora of contact management tools currently available, including: address books, personal information managers, contact relationship managers, organizers, personal computer based products, World Wide Web based products, and others. These utilities all store information such as names, phone numbers, electronic mail addresses, physical mail addresses, and even notes.

In addition, with the rise of electronically based networks and the World Wide Web, new sources of contact information have become available. A main and important new source of contact information is the cadre of “social networks,” or networks of users, providing information. This development has yielded numerous new singular sources of information, one from each social network. Additionally, because of the differential usage preferences for these social networks by the contacts, information quality on the contacts from these networks varies greatly on a per contact and per datum basis. Unfortunately, all prior art relies on some sort of explicit or inherent source level (or source wide) validity judgment or hierarchy. In the context of an increasing number of sources and per contact data quality variability from these sources, these source level data validity judgments that all prior art entail create significant problems.

Traditionally a user would enter information that he/she collected into the contact management system, and that information would be stored and recalled later (FIG. 0). This information is “single user input information,” and format was used in the vast majority of contact information management systems in use before the advent of the World Wide Web. For example, a traditional paper based Rolodex from Berol Corporation of Freeport, Ill. and PC-based systems such as Microsoft Outlook from Microsoft Corporation of Redmond, Wash. and ACT! from Symantec Corporation of Cupertino, Calif. (in their incarnations pre-existing the advent of the World Wide Web and multiple-user networks).

The networked connectivity of the World Wide Web has yielded at least 2 new sources of information for contact management systems. Namely, (1) information provided to the system by the contact (whose information is being collected) directly, or “contact input information” and (2) information provided by a third party, or “third party input information.” There are also systems with multiple users and hence there are sets of “multiple user input information.”

All of these new sources of information, which have arisen or are becoming more prevalent as a result of the rise of the World Wide Web, have enhanced the quantity of information flowing into contact management systems. This rise in quantity has been accompanied by a dramatic increase in quality variability. Pursuant to this influx is a very pressing need for a system which can properly capture all of these various sources of information but at the same time maintain the integrity of and content quality in tile user's contact book.

### PRIOR ART

Contact management systems which use multiple sources of information must have a reliable and trustworthy system for synchronizing and determining which information is most accurate and therefore should be stored in the contact book, or the main data table. All current methodologies and market players satisfy this need in one of two ways—it is important to note that each system discretely, inherently or implicitly has an underlying value judgment as to the validity of the information sources in relation to one another and applies these judgments indiscriminately on a per source (or “source level”) basis to the synchronization process. The main categories which these systems fall into are as follows:
(1) Single Source of Information (FIG. 1). Some systems select a single source to use for all information input, making the inherent judgment that that single source is always the most accurate. This is akin to the pre-World Wide Web single-source systems (Rolodex, Microsoft Outlook, ACT!) except the single source selected is one of the new sources enabled by the advances in internet networking technology.

An example of contact management systems which employ a methodology such as this are online networks which include “profiles,” or indexes of links directly to information posted and supplied by a contact or “contact input information.” This contact input information is a new source which has been specifically chosen over all other sources available to the system, such as the system's user entering information directly. Specifically, LinkedIn.com from LinkedIn Corporation of Mountain View, Calif. uses an index of links directly to information provided by contacts. Thus, LinkedIn Corporation has solved the synchronization problem by choosing one source as superior (in this example, “contact input information”) and only using that information source for information sourcing.
(2) Multiple Sources of Information. Some more advanced systems recognize the importance of using the multiple sources provided by the advances in World Wide Web based networked/networking technology. The majority of these systems fall into two main categories (with subtle variations):
   a. Temporal, Source-Sequence Based Systems. These systems synchronize the sources and subordinated source tables with the contact book (or main data table) in discrete intervals of time. That is to say that the main table is synched to a subordinated table on a 1-on-1 basis at a unique point in time, and no two sources can be compared, viewed or otherwise synchronized with the main table at the same time. For example, the main data table has a set of information at time t. This main table is first synched 1-on-1 with subordinated source table A, at time t_{A}=t+1. New information is pulled into the main table, and discrepancies are resolved. This discrepancy resolution is most often done by system rules, but can also be handled by the user. Later in time, a second subordinated source table, table B, is synched to the main table at time t_{B}=t+2. And third C, at t_{C}=t+3. Critically, regardless of the mechanism by which information is filtered between the subordinated table and the main table (system, user decision, or other) because of the discrete intervals of time for the 1-on-1 synching sessions, there must be a source sequence selected (in the example above, A is before B). Without the ability to compare across sources to determine the best information, the order in which sources are synched with the main table has a material effect. Whether done by system, user or other, the information comparison and selection pattern is dependant on source sequence and there is path (or in this case, “sequence”) dependence. For example, the main table could have the value Y for a certain datum at time t=0. At t_{A}=t+1, source table A has X, so X is now stored at the user's discretion. At t_{B} =t+2, source table B also has X, so no action is taken. At t_{C}=t+3, source table C has Z, so the user decides to pull in Z (the reason behind this decision is irrelevant). It is probable that the accurate information is X, because it is coming from 2 sources. However, the user must remember this, and the more sources that exist, the more the sequence of sources matters for memory and comparison. Understanding that human memory is not perfect, it is likely that within the sequencing of these sources, the user will create some sort of hierarchy, e.g. “I will synchronize with source C last and accept all new updates from it because I think it is the best source”. Thus, inherently, there is a source level bias created when a sequence must be selected by a user. Additionally, if source sequencing is approached with a set of rules in the scenario above, it is easy to see that if pulling in discrepancies automatically from a subordinate table to a main table, the temporal sequence of synching sessions t_{A}→t_{B}→t_{C} which yields an ending main table value of Z, differs from a temporal sequence of t_{A}→t_{C}→t_{B} which yields and ending main table value of X. With this temporal source sequence dependence understood, it is finally important to note the inherent requirement for having a temporal sequence of sources in any and all 1-on-1 synching processes. By the nature of 1-on-1 synching there must be a temporal sequence. Taking these points together: the path (or in this case sequence) dependence of the final stored data and the necessity for a temporal sequence in 1-on-1 synching systems; one must conclude that when a temporal sequence is selected for the sources, some broad value judgments on the sources (made by the system, user or other mechanism) is made (in the example above, the last source “synched,” either C or B, would be the “favored” source in the inherent hierarchy, because it dictates the final datum stored, Z or X respectively). This inherent hierarchy and implicit source bias, paired with the growing number of sources and diverse quality of information on a per contact and even per datum level yields numerous problems for the user including, but not limited to, loss of time, information and confidence in the system.

The following provide examples of the two main types of temporal sequence based systems.
(i) System Dictated Info Selection (FIG. 2A): Examples of a contact management systems which employ this methodology are BigContacts.com Inc. of Duluth, Ga.; HandyAddressBook.com from Beiley Software Inc. of Chandler, Ariz.; Jigsaw.com from Jigsaw Data Corporation of San Mateo, Calif. and networked versions of prior “single user input information” based systems which are now networked with multiple users, such as Microsoft Outlook and ACT!. These systems have a single main information table. As new information is brought into the system from different sources, the last information entered is automatically assumed to be most accurate by the system, and is therefore stored in the main data table. Thus there are discrete synching sessions, and the discrepancies and updates are pulled in based on the “latest information to be synched is best” implicit Temporal, Source-Sequence Hierarchy.
(ii) User Dictated Info Selection (FIG. 2B): Examples of this type of a contact management system are those used by Cadiz et al. in U.S. patent applications Ser. No. 11/066,715 (Pub. No.: US 2006/0195472 A1) and Ser. No. 11/067,615 (Pub. No.: US 2006/0195474 A1). These systems, although slightly different in usage case, represent systems with 1-on-1 synching for which one embodiment (page 5, section [0036]) includes user discretion over information flow during 1-on-1 discrepancy resolution, similar to the example given in Section 2(a)). Critically, because the synching is done on a 1-on-1 basis in these systems, and there is sequence dependence of information flow (as established above in section (2)a), these systems still necessarily create a temporally dependent implicit source hierarchy when a sequence is selected.
b. Strict Source Hierarchy Rules Based Systems (FIG. 2C). These systems establish and embed within the technology a hierarchy of the sources independent of time. For example, source A is ranked higher than source B in the hierarchy. If there is information being imported into the single main table of the system from both source A and source B, the system will use the information coming in from source A, as it is ranked higher in the hierarchy, regardless of the temporal order of synching. Another example is if there is already information in the table from source A, and new information from source B is imported, the existing information from source A will not be written over, because it is ranked higher in the source hierarchy. There are many variants of these systems, including systems which have numerous hierarchies (or even an indefinite number of hierarchies) and let the user or some other mechanism select which to apply. Other embodiments could be systems which rank sources based on historical user selections and decisions, or systems which utilize statistics on information consistency or similarity between and among sources. For consideration here, the most important facet to all of these systems is that once a hierarchy is selected it is applied indiscriminately across all contacts, all processes, all pieces of information and the entire synchronization process. This source level explicit bias, paired with the growing number of sources and diverse quality of information on a per-contact level yields numerous problems for the user including, but not limited to, loss of time, information and confidence in the system.
   An example of a contact management system which employs this methodology is that of Plaxo, Inc. of Mountain View, Calif. (U.S. Pat. No. 7,080,104). This system takes input from both the user and the contact. However, this system has a hierarchy that ranks contact input information over user input information, because of the implied superiority of information supplied directly from the contact.

Therefore, if there is differing information between the two sources, the system automatically selects the contact provided information, in accordance with the information source hierarchy. This hard coded hierarchy in the system can be proactively altered by the user after the synching has occurred, however the risks of time, information and confidence loss remain present.
A second example of a source hierarchy rules based system is the subject of the mechanism developed by Arbo, et al (US Patent Application Pub. No.: 2004/0093342). This is a system which has a stable of pre-determined hierarchies which the user can select. While this system provides numerous (even potentially infinite) hierarchy options, once one is selected by the user, it is applied indiscriminately across the synchronization process.

All current methodologies for synchronization of contact management systems with multiple information sources rely on one of the aforementioned avenues. All of these mechanisms maintain a single, central table of contact information into which information is either copied or not copied via one of the aforementioned methodologies. In addition, each system has basic explicit, inherent or implicit source level value judgments or biases built into the framework of the technology and then applied across all synchronization points indiscriminately.

For Single Source Systems, the technology assumes that the single chosen source is superior to all other sources on all occasions. For a Temporal, Source-Sequence Based System, a source sequence must be determined which due to the path dependant nature yields inherent source level biases, whether intended or not. For a Strict Source Hierarchy Rules Based System, the technology assumes that one source is always superior or inferior to others in terms of accuracy across all decision points.

Thus, all current solutions to the problem of synchronization of contact information from multiple and widely varying sources rely on technology which in one form or another, inherently assumes one source of information is better than another at the source level, and not at the per contact or per datum level. These current solutions do not properly address the synchronization of contact information from different sources because they ignore the reality that different sources will have accurate information at different times for different contacts and for different pieces of information. This is increasingly important as more sources of information become available and the variability of the quality on a per contact basis increases. Building value judgments into this technology and applying them indiscriminately at the source level yields the following significant problems:
(1) Potential Loss of Information—because the synchronization methodologies of all of these current systems have source level value judgments and biases applied indiscriminately for synchronizing the information and selecting sources, there is the potential for loss of information. For example, a contact could accidentally or maliciously enter the wrong information for their phone number. In Plaxo Inc.'s model, the user could initially enter the accurate information. However, when the contact enters inaccurate/erroneous information on purpose or by accident, Plaxo Inc.'s technology would automatically replace the user input information with the incorrect information provided by the contact. This is directly caused by the hard coded rules for selecting information and sources embedded in the technology. A similar scenario is imaginable for any of the other synchronization methodologies currently in use and noted in the Prior Art. For example, single source systems are at the greatest risk of losing information from other sources because they completely disregard these other sources in favor of the single selected source. If accurate information is supplied by other unselected sources, this information is lost to single selected source systems.
(2) Non-Transparent Information Sourcing in Multi-Sourced Systems—For many of the current systems which utilize Temporal, Source-Sequence Based and Strict Source Hierarchy Rules Based models, the methods and rules are themselves not transparent. As a result, a potential problem is determining the source of information, and in turn validating that information. A pertinent example of this is using a newer networked version of ACT! with multiple user input sources (i.e. there are multiple users inputting information into the same table). The ACT! system is a Temporal, Source-Sequence Based System which relies on System Dictated Info Selection (Section 2(a)(ii)); in other words, in this case the latest entered information is automatically assumed to be the most accurate, regardless of which user accesses and inputs the information into the main table. A resulting issue of this type of system is the inability to track down and validate a source of information. This inability to validate a source is due to the problem that in many of these systems, the methodology and rules for synchronization are not made readily apparent.
(3) End User Distrust of Content—Because of the two aforementioned issues with current systems, the ultimate result is that end users of the system tend to trust the content far less than would be desirable, if at all. This is a major issue, especially for something that is as integral to many people as professional and personal contact information management.
(4) Extensive Requirements of System User—In many systems, such as the User Dictated Info Selection embodiment of the Temporal, Source-Sequence Based Systems (Section 2(a)(ii)), there are excessive requirements of the user which make the system cumbersome. In these systems, for example, the 1-on-1 synching sessions require that the user attempt to remember information from previous sources and synch sessions, attempt to create a source hierarchy so as to minimize the loss of information, and probably most importantly, perform the time consuming 1-on-1 synching process for each source of many. It is easy to extrapolate how this can become prohibitively burdensome in the context of numerous sources with widely varying degrees of information quality.

Thus, it would be of great advance and significance, if a novel system was created in which all sources of information were harnessed, while simultaneously the synchronization of these sources was not influenced by a system which relics on explicit, inherent or implicit source validity judgments and biases.

### SUMMARY OF INVENTION

Our invention solves the above problems (among others) by a novel model consisting of a stand-alone, custom and private contact book for each user, the content in this contact book is either entered directly by the user, or selectively pulled from exogenous sources. More specifically this is done by maintaining a main data table and a subordinated table for each exogenous information set as well as incorporating a user decision node in the synchronization process which controls all information flowing from the subordinated source tables and into the main table. This novel system provides a methodology which harnesses many of the different sources of information input but does not rely on any source level value judgments on source validities or create any explicit, inherent or implicit source hierarchies or biases. No other systems currently accomplish this task; no other market players recognize it as a possibility and advancement over current methods.

This innovation, shown in FIG. 3, maintains a main data table of contact information. In addition to this main table, there are numerous (infinite, or “n”) subordinated tables, one for each information source (e.g. there is a subordinated table A for source A, a subordinated table B for source B, and so on, in addition to the main table). A user decision node is located between the main data table and these subordinated source tables. Any new information must necessarily flow through this user decision node at the direction of the user.

In this manner, the system is able to emancipate the synchronization method from indiscriminate application of source value judgment and hierarchies and rely instead on the user decision node. Simultaneously, through the use of the subordinated table and main data table mechanism, the system is able to harness many of the differing sources of information without the drawback and risks of other systems, as previously noted. Because of the structure, there is no need for 1-on-1 synching sessions. This new method results in a solution to the main problems of all previous systems, which include:
(1) Potential Loss of Information
(2) Non-Transparent Information Sourcing in Multi-Sourced Systems
(3) End User Distrust of Content
(4) Extensive Requirements of System User

The user controls the flow of information between the subordinated tables and main table via the user decision node on a per contact and/or per datum basis (addressing problems 1 & 2). The solution to these two issues yields a greater trust in the content of the main table of contact information (addressing problem 3). Because, among other aspects, user decisions and interactions with the system are aggregated into a single node (and thus minimized), the user can compare, view and evaluate multiple subordinated tables versus the main table at the same time, which requires significantly less effort than 1-on-1 synch sessions with each source (addressing problem 4).

In summary, the growth of the World Wide Web has yielded new sources of contact information with information quality varying greatly on a per contact and per datum basis. These sources need to be properly synchronized in order to be effectively utilized. Current mechanisms for synchronization all rely on inherent or explicit source hierarchies or judgments on the validity of the sources. These source level (or per source) decisions yield problems such as loss of information and ultimately distrust of the content of the contact management system, among others. Our novel model uses multiple subordinated information tables (each for a different source) and a main information table, and a user decision node placed between the main data table and the subordinated source tables. At this decision node the user is able to simultaneously view information from all sources and the main data table, and then dictate which, if any, information or data should be transferred from a source data table into the main data table. Thus, our system harnesses numerous information sources, incorporates a user decision node, and most critically does not make any source level (i.e. source wide) source validity judgments, either inherently or explicitly. As a result, our invention is not vulnerable to the problems plaguing the Prior Art and is a valuable innovation in the context of an increasing number of information sources with an increasing data quality variability on a per contact and per datum basis.

### BRIEF DESCRIPTION OF THE DRAWINGS

FIG. 0—Single User Source System. FIG. 0 displays the layout of contact information management systems prior to the advent of the World Wide Web and networked personal computers. In these systems, the only source of information was the single user, who would input information into the system and recall it later.

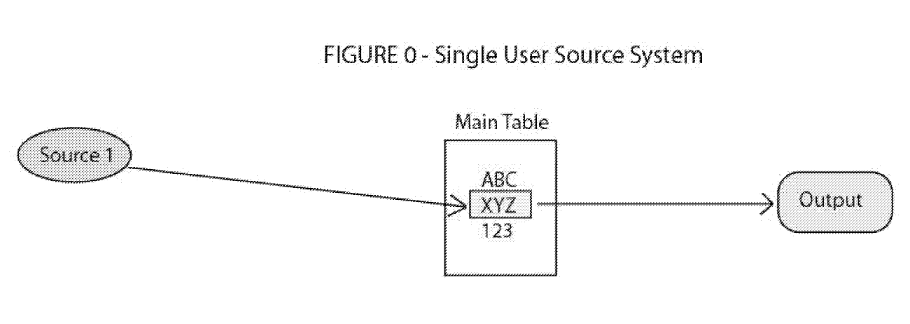

FIG. 1—Single Selected Source System. FIG. 1 displays the layout of a contact information management system which is enabled by multiple sources of information via the World Wide Web and/or networked personal computers. In this figure, one source of information is chosen as superior to all other sources indefinitely, and therefore is the only source of information used and all others are ignored.

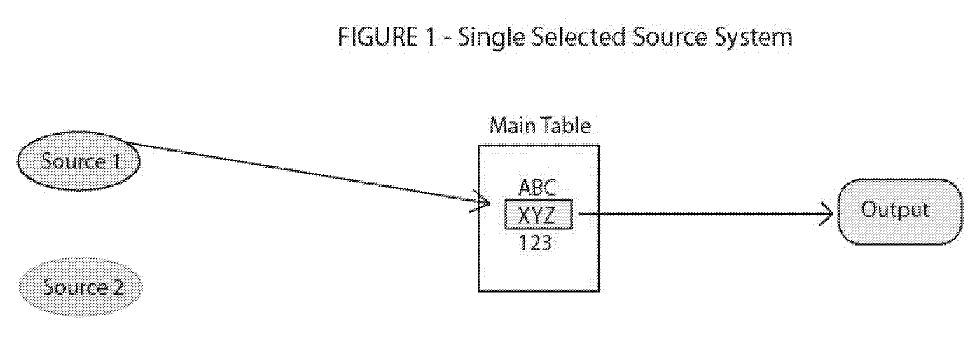

FIG. 2A—Temporal, Source-Sequence Base Systems: Systems Dictated Info Selection. FIG. 2A displays the layout of a contact information management system which is enabled by multiple sources of information via the World Wide Web and/or networked personal computers. In this figure, a rules system is used to decide between conflicting information. The most recent information presented to the system (regardless of the source) is assumed to be the most accurate, in this example. As such, because there is source sequence dependence there is necessarily an implied/inherent hierarchy via the source sequence selected.

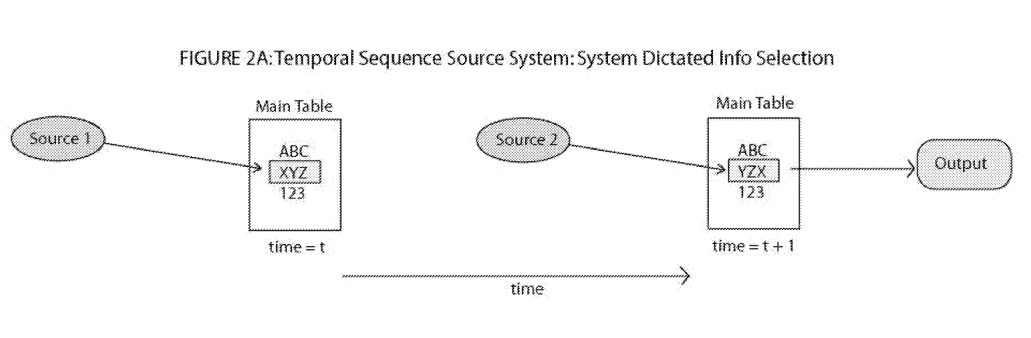

FIG. 2B—Temporal, Source-Sequence Base Systems: User Dictated Info Selection. FIG. 2B displays the layout of a contact information management system which is enabled by multiple sources of information via the World Wide Web and/or networked personal computers. In this figure, a user decision is used to decide between conflicting information. As there is a source sequence dependence even when the user is deciding (caused, in part, by limited human memory), there is still necessarily an implied/inherent hierarchy via the source sequence selected.

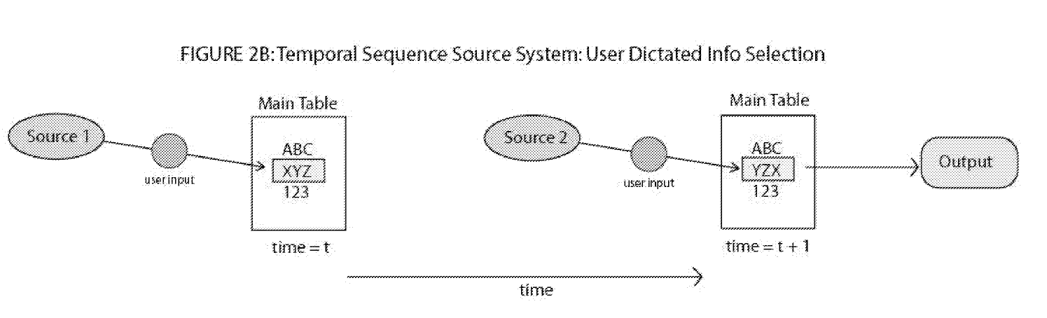

FIG. 2C—Strict Source Hierarchy Rules Based Systems. FIG. 2C displays the layout of a contact information management system which is enabled by multiple sources of information via the World Wide Web and/or networked personal computers. In this figure, a rules based system is created in which information sourcing decisions are dependent on a predetermined hierarchy. This hierarchy can be determined by the user, or is often hard coded into the systems themselves.

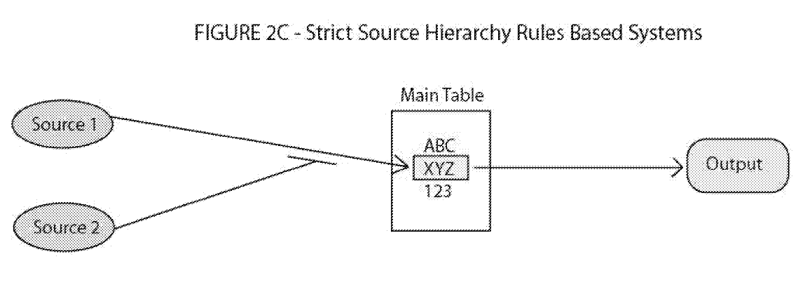

FIG. 3—Our Technology: Main and Subordinated Tables Structure with Single User Decision Node. FIG. 3 displays the layout of a contact information management system which is enabled by multiple sources of information via the World Wide Web and/or networked personal computers. In this novel system, information from all sources is collected into corresponding subordinated tables. These tables are then compared to the main table (accessed by the user for information output). Any discrepancies between the main table and the subordinated tables are brought to the attention of the user at a “user decision node,” where the user makes decisions on the validity of specific pieces of information. These decisions dictate which information is copied to the main table, and which is not copied to the main table.

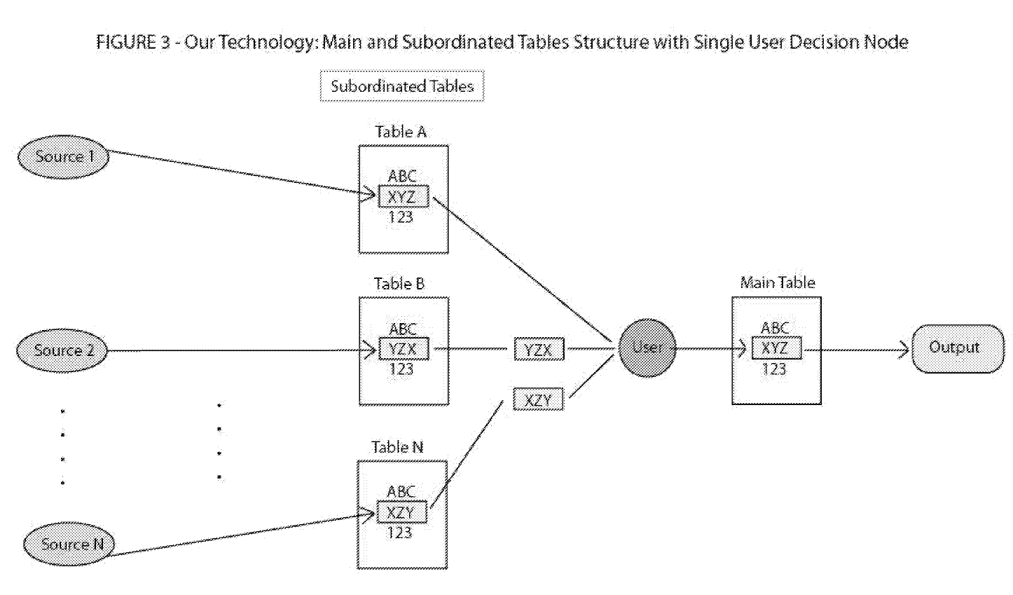

We claim the following:

1. A system associated with a remote server accessed via vehicles such as the World Wide Web. This mechanism stores, categorizes and indexes personal and professional contact information such as, but not limited to, names, phone numbers, electronic mail addresses, physical mail addresses, and notes.

2. The system claimed in 1, wherein each user of the system has a custom, private and self-contained database of information on his/her contacts, i.e. a contact book or main data table.

3. The system claimed in 2, wherein the user can enter information directly into his/her contact book or main data table.

4. The system claimed in 3, wherein information can be selectively or automatically pulled into subordinated source tables from numerous (infinite or “n”) outside sources.

5. The system claimed in 4, wherein outside sources can include, but are not limited to, the user(s) of the mechanism, the contact to whom the contact information pertains, and third parties who neither use the mechanism nor are referenced by the contact information.

6. The system claimed in 5, wherein the information from these outside sources can be in many different forms, including, but not limited to outside offline contact management systems, outside online contact management systems or outside online social networks.

7. The system claimed in 6, wherein the database, main data table and subordinated source tables are stored on a remote server.

8. The system claimed in 7, wherein there is a main table which stores contact information and is accessed by an account user(s).

9. The system claimed in 8, wherein there are subordinated tables in conjunction with the main table.

10. The system claimed in 5, wherein each outside source of information has a corresponding subordinated table.

11. The system claimed in 10, wherein the information in each subordinated table is compared to the corresponding entry in the main table.

12. The system claimed in 11, wherein all similarities between the corresponding subordinated tables and the main table are channeled through a user decision node and/or are ignored.

13. The system claimed in 12, wherein any differences between the corresponding subordinated tables and the main table are channeled through a user decision node.

14. The system claimed in 13, wherein the user decision node consists of a user who decides whether or not to copy information from the subordinated table to the main table.

15. The system claimed in 14, wherein there are no inherent, inferred, implicit, implied or explicit source level or per source data validity judgments, hierarchies, preferences or biases built into the system.
